(19) United States
(12) Patent Application Publication
(10) Pub. No.: US 2022/0327491 A1
(43) Pub. Date: Oct. 13, 2022

(54) METHOD AND SYSTEM FOR COMPETENCY BASED ASSESSMENT

(71) Applicant: Robert Peter Smart, Ottawa (CA)

(72) Inventor: Robert Peter Smart, Ottawa (CA)

(21) Appl. No.: 17/730,831

(22) Filed: Apr. 27, 2022

Related U.S. Application Data
(63) Continuation-in-part of application No. 16/625,337, filed on Dec. 20, 2019, now abandoned.
(60) Provisional application No. 62/523,305, filed on Jun. 22, 2017.

(51) Int. Cl. G06Q 10/10

(52) U.S. Cl. CPC G06Q 10/1053

(57) ABSTRACT

The present invention is directed to a system and method for competency assessment and verification. The system includes a task and criteria module for defining tasks and criteria, an evidence module for receiving task and criteria evidence and an assessment module for assessing tasks and criteria based on the received evidence, in a web-based environment. The evidence module may include a documentary component and a video component for receiving documentary and video evidence. The assessment module may include an evidence indexing or annotating component for location indexing of documentary evidence and time indexing of video evidence.

### CROSS REFERENCE TO RELATED APPLICATIONS

This application is a continuation-in-part of U.S. application Ser. No. 16/625,337 filed Dec. 20, 2019, which is a U.S. National Phase of International PCT Application No. PCT/CA2018/050763 filed Jun. 22, 2018, which claims priority to U.S. Provisional Patent Application Ser. No. 62/523,305 filed Jun. 22, 2017, each of which is incorporated herein by reference in its entirety.

### FIELD OF THE INVENTION

The present invention pertains to the field of assessment and verification of competencies, and in particular to a method and system for electronic assessment and verification of competencies contained within an electronic portfolio.

### BACKGROUND

Historically, an evaluation of a candidate for employment, accreditation or certification would be based on the candidates' education and qualifications, e.g., does the candidate know what to do. Recently, there has been an increase in evaluating candidates based on their competency, e.g., does the candidate know how to do it.

Competence has been defined in International Organization for Standardization (ISO) Standard 19011:2011 as the ability to apply knowledge and skills to achieve intended results. When a candidate is evaluated based on that person's competency, his knowledge, skills, personal attributes, and qualifications specific to the job duty and/or scope of certification is examined. On the other hand, when a candidate is evaluated based on that person's qualifications, the candidate's education and qualifications are examined rather than based on measurable competence. The following example further highlights the difference between competency and qualification. In response to the question, “Do you know how to drive a car?” A candidate response, “I have acquired a driving license, but I am still not confident to drive a car.” This response demonstrates the candidate has the qualification, but not the competency, to drive a car.

Recognizing that competency-based evaluations, accreditations, and certifications provide a more thorough evaluation than one based on qualifications alone, companies and organizations have started to require competency-based training and evaluations. For example, ISO/IEC Standard 17024 Conformity Assessment—General requirements for bodies operating certification of persons, mandates that the certification of persons should be based on the demonstration of competencies and not the demonstration of qualifications. ISO/IEC 17024 sets the requirements and the framework, at a global level, for the operation of Personnel Certification Bodies (PCB). By using ISO/IEC 17024, business, industry, and other key stakeholders have recognized that competency-based certification is the optimum way of achieving confidence in persons certified by PCBs. In another example, in the Caribbean, five competency-based levels of certification have been articulated to the tradesman, craftsman, technician, technologist and engineer.

The assessment of competency including the assessment of the ability to perform a specific activity or function is also relevant in education, and in health and wellness. Assessment of changes in competency can be used to monitor the effectiveness of training and/or treatment regimens and/or to monitor age-related decline or disease progression.

When examining or assessing the competency of a candidate, the assessment must be valid, reliable, and independent. There is a need for an efficient competency-based assessment system that is valid, reliable, and independent.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide a method and system for competency-based assessment. In accordance with an aspect of the present invention, there is provided a computer-implemented method of conducting a competency-based assessment of a candidate.

In accordance with embodiments of the present invention, there is provided a method of indicating a compliance criteria. The method includes receiving a digital file including evidence of a performance of a task where the task is required to show a competency in an ability. Also determining, in response to a first user input, a selection of the digital file demonstrating the performance of the task. Also, tagging, in response to a second user input, a description of the ability to the selection, and storing the selection of the digital file, the digital file, and the description.

In further embodiments, the digital file is an audio/visual (AV) file, and the selection includes a timestamp.

In further embodiments, the AV file is a video file, and the timestamp is determined using a JavaScript method. The timestamp indicates a time in the video file corresponding to the performance of the task.

In further embodiments, the JavaScript method is a currentTime method.

In further embodiments, the ability is selected from a list of a plurality of tasks required to show competency.

In further embodiments, the selection is annotated in the digital file.

In further embodiments, the description includes a criteria indicating whether the performance meets the compliance criteria.

In further embodiments, the digital file is a text image file and determining the selection includes selecting a rectangular portion of the text image file.

Further embodiments include performing character recognition on the rectangular portion where the selection includes text obtained by the character recognition.

Further embodiments include linking a second digital file to the selection and storing the second digital file with the selection of the digital file, the digital file, and the description.

Further embodiments include determining a probability that the digital file includes evidence of a performance of a second task required to show a competency in a second ability.

In accordance with embodiments of the present invention, there is provided a method of reviewing a compliance criteria. The method includes receiving a digital file evidence of a performance of a task where the task is required to show a competency in an ability. Also receiving a selection of the digital file and a description of the ability where the selection demonstrates performance of the task. Also displaying the digital file with the selection indicated as an annotation in the digital file, and in response to a user selecting the annotation or the description, displaying a portion of the digital file including the selection.

In further embodiments, the digital file is an audio/visual (AV) file, and the selection includes a timestamp.

In further embodiments, the AV file is a video file and displaying a portion of the digital file including the selection includes using a JavaScript method to play the video file from a time indicated by the timestamp.

In further embodiments, the JavaScript method is a “playfrom” method.

IN further embodiments, the description is selected from a list of descriptions of a plurality of tasks required to show competency.

In further embodiment, the description includes a criteria indicating whether the performance meets the compliance criteria.

It is to be understood that both the foregoing general description and the following detailed description are exemplary and explanatory only and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE FIGURES

Further features and advantages of the present invention will become apparent from the following detailed description, taken in combination with the appended drawings, in which:

FIG. 1 is a flow chart depicting the competency assessment system according to an embodiment of the present invention;

FIGS. 2a and 2b are a diagram of a screen print depicting a summary of the status and detail of a user according to an embodiment of the present invention;

FIG. 3 is a diagram of a screen print depicting a graphic summary of the accomplishments of a user according to an embodiment of the present invention;

FIG. 4 is a diagram of a screen print depicting a video evidence submission having a criteria time tracking notation therein according to an embodiment of the present invention;

FIG. 5 is a diagram of a screen print depicting a user submission in the form of a certification according to an embodiment of the present invention;

FIG. 6 is a diagram of a screen print depicting a detailed view of a user's tasks and criteria portfolio according to an embodiment of the present invention;

FIG. 7 is a diagram of a screen print depicting an example of how guidance can be provided to a user according to an embodiment of the present invention;

FIG. 8 is a diagram of a screen print depicting user submissions and video evidence as evidence according to an embodiment of the present invention;

FIG. 9 is a diagram of a screen print depicting a listing of tasks and criteria along with video and written documentation as evidence according to an embodiment of the present invention;

FIG. 10 is a diagram of a screen print depicting a video submission having an assessment of sufficient according to an embodiment of the present invention;

FIGS. 11a and 11b are diagrams of a screen print depicting a video submission having an assessment of insufficient according to an embodiment of the present invention;

FIG. 12 is a diagram of a screen print depicting a signature signoff according to an embodiment of the present invention;

FIG. 13 is a diagram of a screen print depicting a time indexing feature of the present invention according to an embodiment of the present invention;

FIG. 14 is a diagram of a screen print depicting a written document as evidence and showing a highlighted portion thereof used for tracking of deletion of tasks in criteria according to an embodiment of the present invention; and

FIGS. 15a and 15b are diagrams of a screen print depicting a dashboard of a user according to an embodiment of the present invention;

FIG. 16 is a diagram of a method for including a timestamp in a video file, according to an embodiment of the present invention.

### DETAILED DESCRIPTION

The present invention pertains to the field of assessment and verification of competencies, and in particular to a system for electronic assessment and verification of competencies contained within an electronic portfolio.

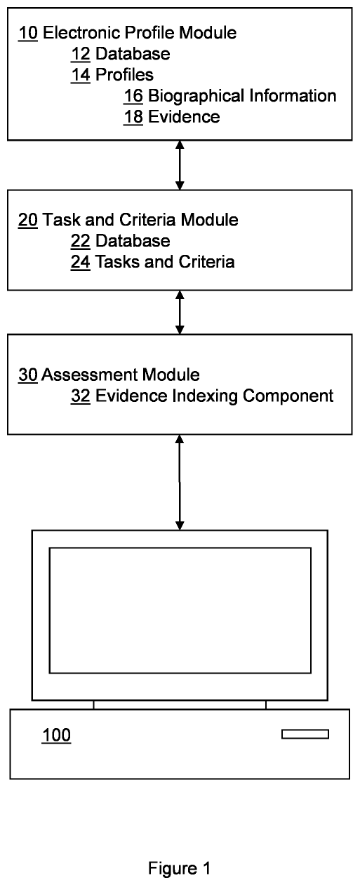

An embodiment of the present invention is shown in FIG. 1 as system 1. System 1 comprises an electronic profile module 10, a task and criteria module 20, and an assessment module 30, which may be in an on-line, web-based environment 100. An on-line web-based environment 100 is defined as any suitable database, hardware, software, network, or application, including but not limited to, intranets, internets, or any other web-based environment available on a single computer, a network of computers, a local server, one or more hand-held mobile devices, or on an intranet or on the internet and world-wide-web.

In general operation, this embodiment of the system allows a user to create an electronic profile 14 of a candidate, which could be themselves or another person. The profile identifies the person's competency level of various abilities. Competencies can be defined as a set of context-specific qualities, such as but not limited to, related knowledge, skills, abilities, and attributes that form a candidate's ability to perform a job. Competencies can be correlated with superior job performance and can be used as a standard against which to measure job performance as well as to develop, recruit, and hire employees.

The competencies or competency indicators in this embodiment include various tasks and criteria 24. The tasks and criteria 24 are stored in the task and criteria module 20. Evidence 18, which is submitted by or on behalf of the person, is evaluated through the assessment module 30. This embodiment of the system 1 may be capable of proving desirable standards that a candidate has established a competency in an ability in an open and transparent manner. Overall, this embodiment of system 1 allows for the assessment of person's competency in an ability, not whether someone has a specific credential i.e., whether someone has the ability, e.g., know how, to perform a job duty as opposed to just having a degree or diploma or certificate.

Electronic profile module 10 may comprise a database 12 of electronic profiles 14 of one or more candidates. An electronic profile 14 can be defined as a record that provides actual evidence of achievement and may contain biographical information 16 of a candidate in the case of where the candidate is a person, such as but not limited to name, address, title, age, and image of person; and may also contain a collection of electronic evidence 18 of achievement, such as but not limited to input text, electronic documents, images, videos, blog entries, multimedia presentations, and hyperlinks. Where the candidate is other than an individual person appropriate biographical information may be provided as would be apparent to one skilled in the art.

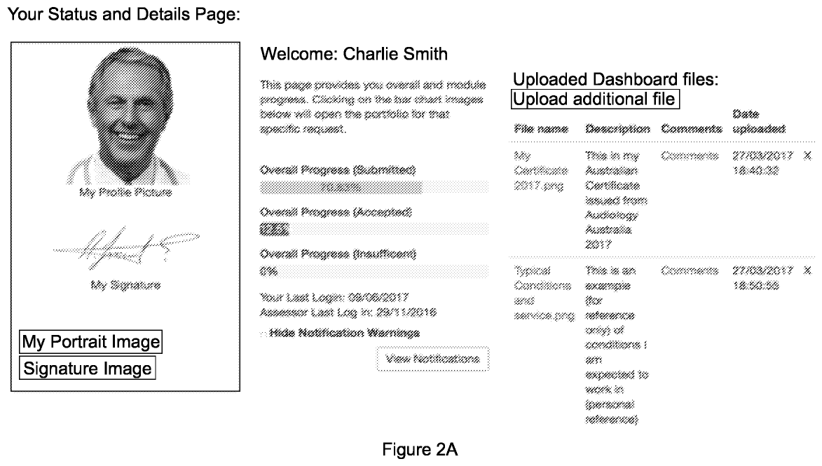

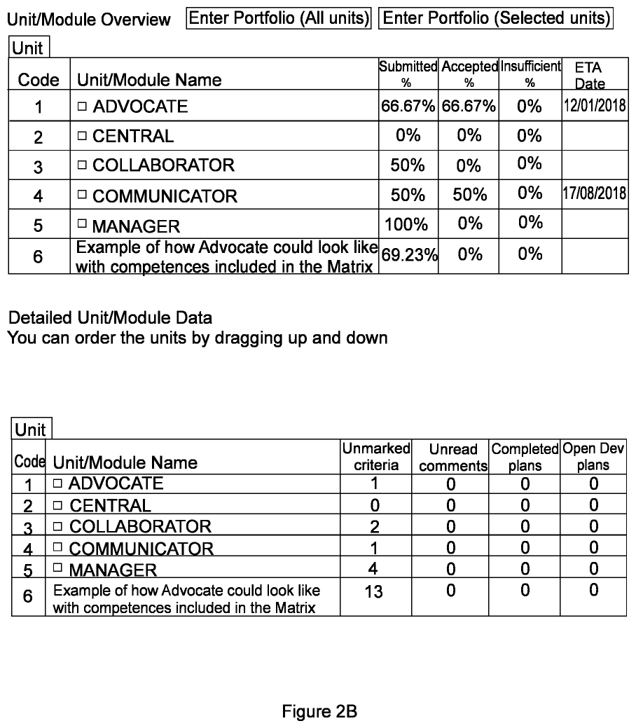

An embodiment of an electronic profile 14 is shown in screen shot FIG. 2 which depicts the name of a candidate associated with the profile, the evidence that has been submitted by the person, a listing of the various competencies the person is attempting to satisfy and the current progress toward satisfying those competencies.

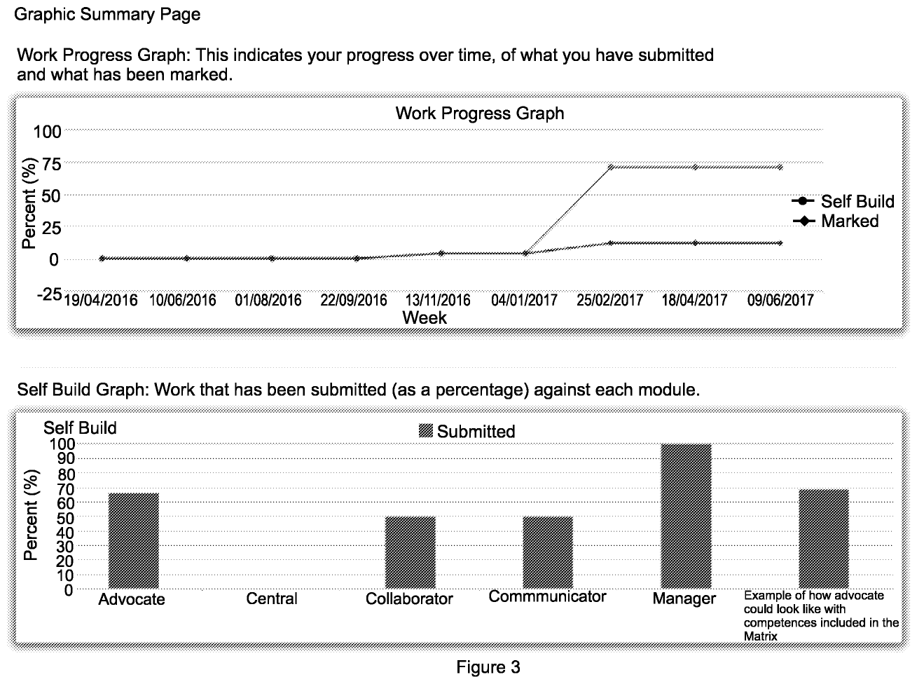

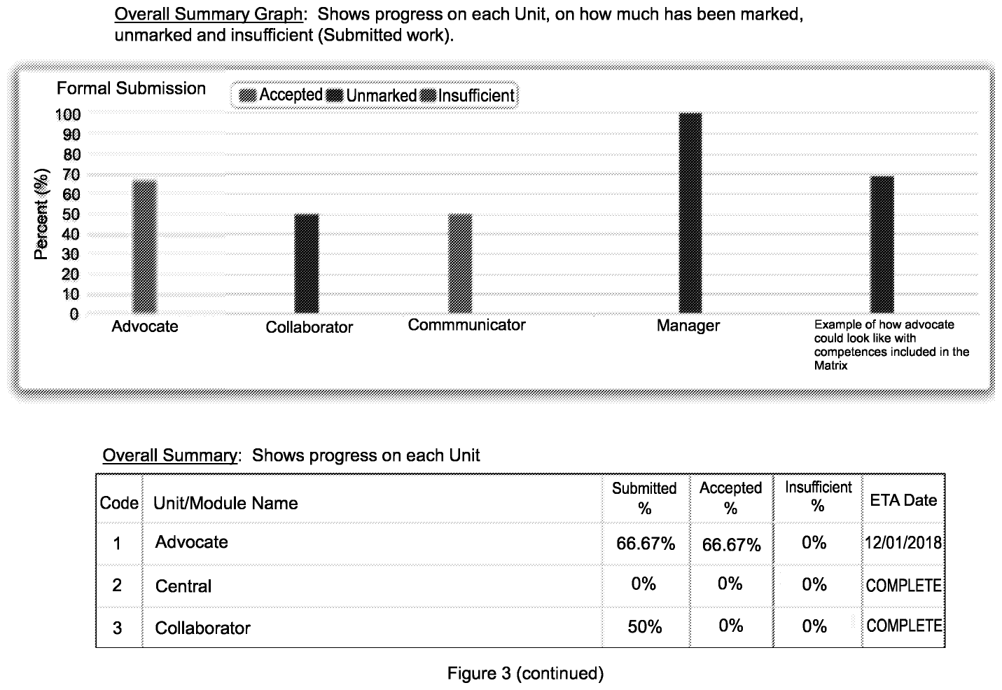

Another embodiment of an electronic profile 14 is shown in screen shot FIG. 3 which depicts graphical representation of the current progress toward satisfying a candidate's competencies.

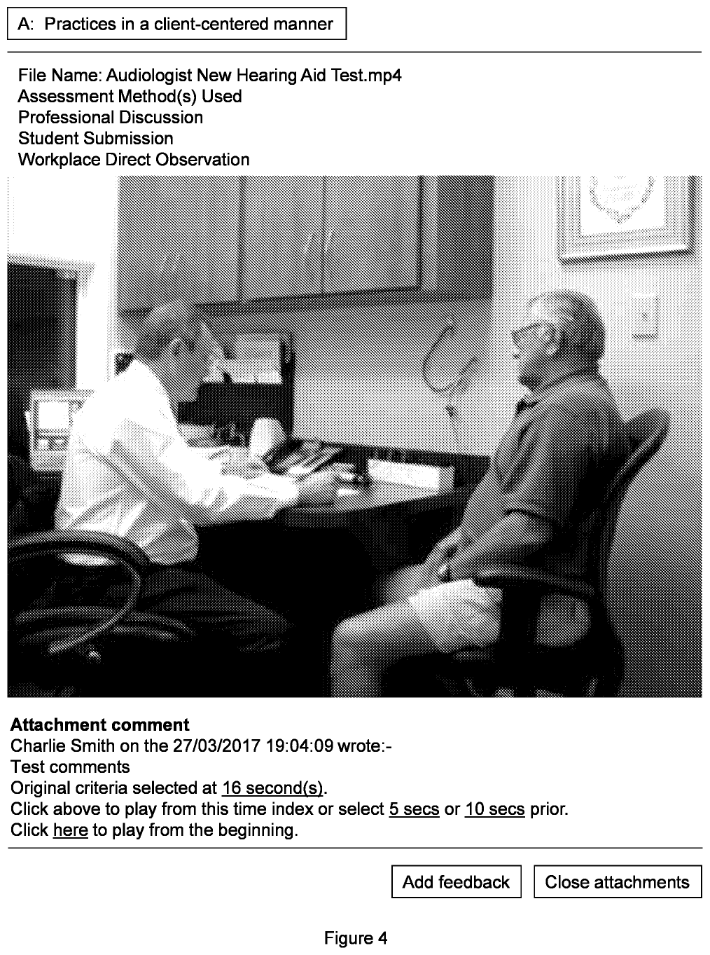

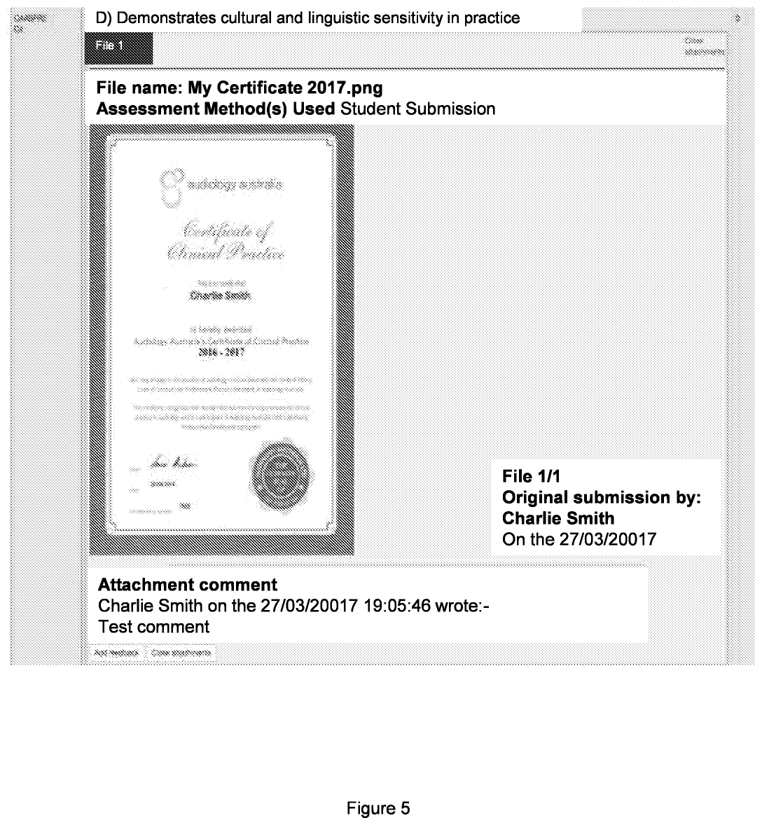

Another embodiment of an electronic profile 14 is shown in screen shots FIGS. 4 and 5 which depicts documentary and video evidence 18 of achievement and activity to be assessed toward satisfying a candidate's competencies.

Regarding the evidence that may be submitted, in some embodiments, the system 1 is configured to allow for submission of evidence by only the candidate or representative of the candidate who is the subject of the profile, a third party or a combination of sources. For example, assuming system 1 is being utilized in a vocational education setting where each student has a profile and each student, along with various faculty and staff, have access to each student's profile. System 1 may be configured to allow the submission of evidence by the student and the various faculty and staff. Further, system 1 can be configured to allow the submitted evidence to be updated. For example, a student uploads video evidence showing a student completing a specific assignment into system 1 where it is determined that the student only has obtained partial competency in an ability. System 1 may allow the video evidence to be updated by the student or other party to demonstrate a complete competency in the ability.

Task and criteria module 20 may comprise a database 22 of various tasks and criteria requirements 24 for various competencies. For example, a welder desires to become recognized as a master welder. To obtain this recognition, the welder must have specific competencies in that field. These competencies can be further defined as a set of tasks and criteria, such as but not limited to, a consistent weld success rate documented by various testing methods, e.g., Magna Flux testing and X-ray testing; proficiency with welding techniques, e.g. Arc welding and knowledge of metal composition and configuration. Task and criteria module 20 may store these various tasks and criteria 24 and may be linked to the welder's profile. The welder will be able to determine what tasks and criteria are needed to be demonstrated before the recognition of master welder can be obtained.

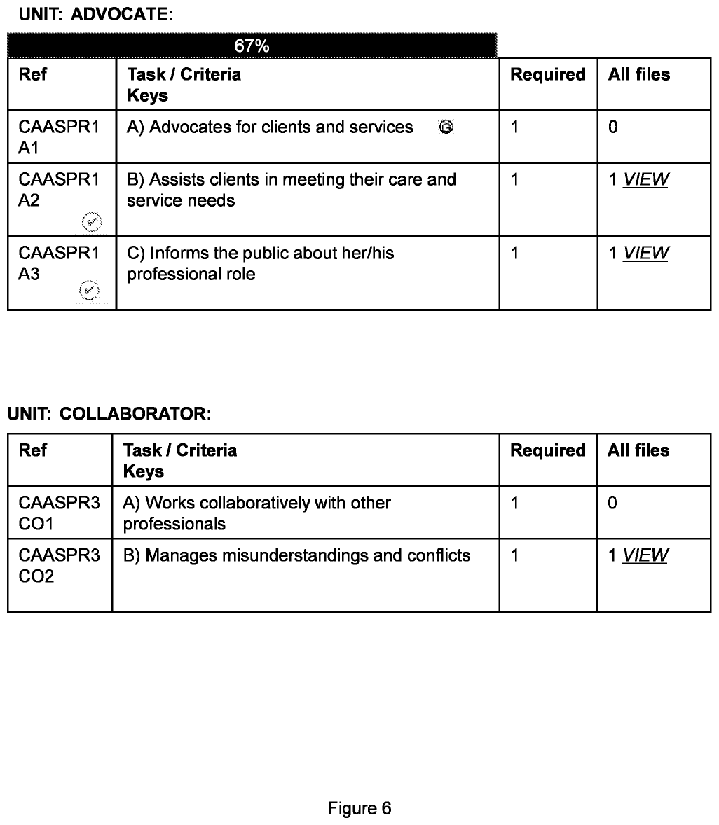

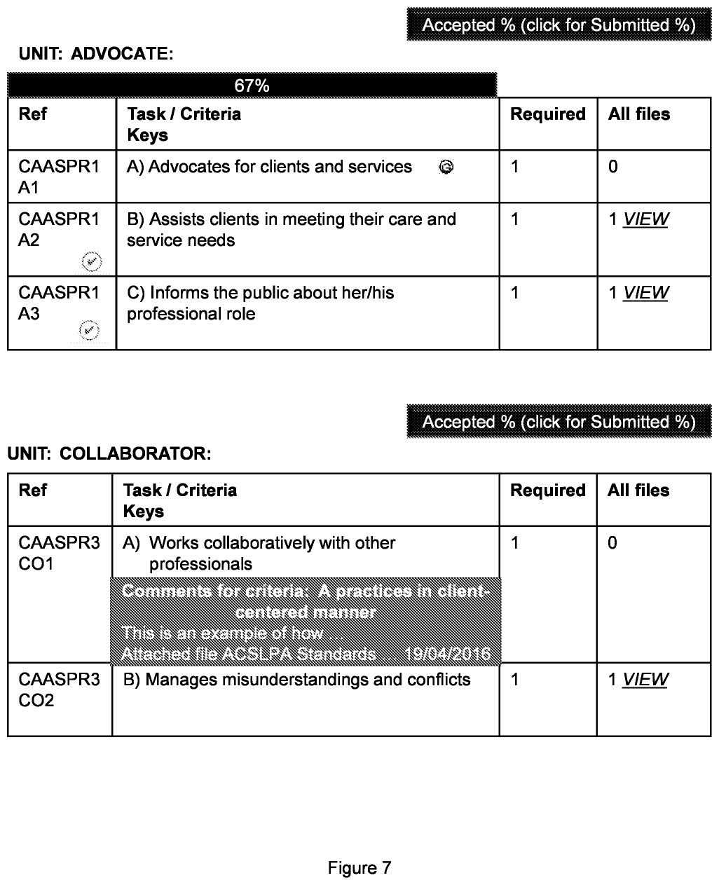

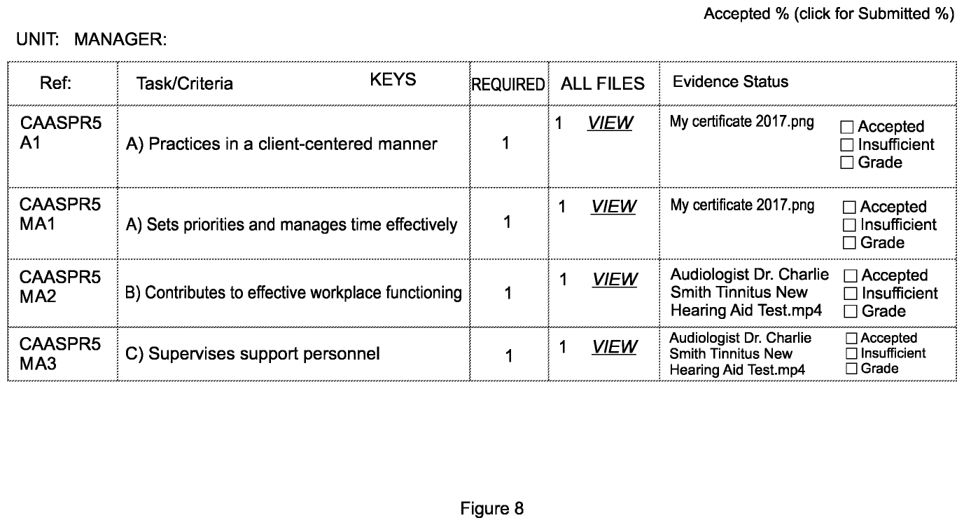

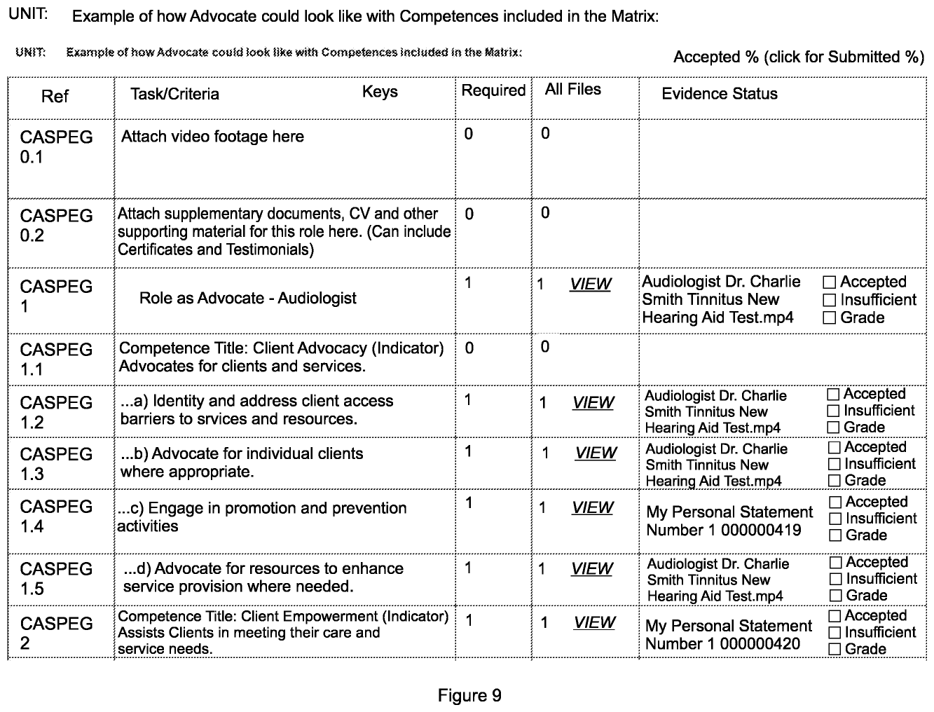

Embodiments of task and criteria module 20 are shown in screen shot FIGS. 6-9 which depict various tasks and criteria for various competencies.

Assessment module 30 allows an evaluator to review evidence 18 submitted on behalf of a candidate in order to assess the person's competency in an ability. Assessment module 30 provides the evaluator with the capability of reviewing evidence 18 in conjunction with the tasks and criteria 24 requirements for a particular competency. The evaluator can determine if the evidence is sufficient or not sufficient to establish that a candidate has satisfied the necessary tasks and/or criteria for a specific competency. The assessment module 30 further provides the evaluator the capability of providing a grade as related to a particular task or competency.

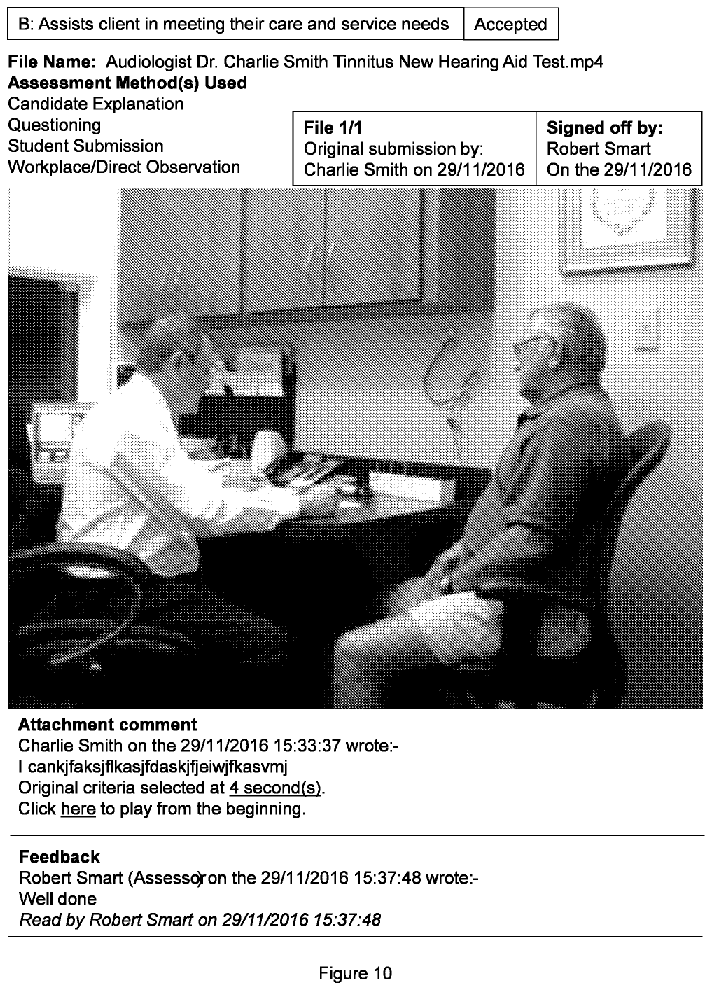

As an example, embodiment of assessment module 30, as illustrated in screen shot FIG. 10, a video, that has been submitted as evidence 18 of competency of the task “Assists clients in meeting their care and service needs” has been determined to be accepted by the Assessor.

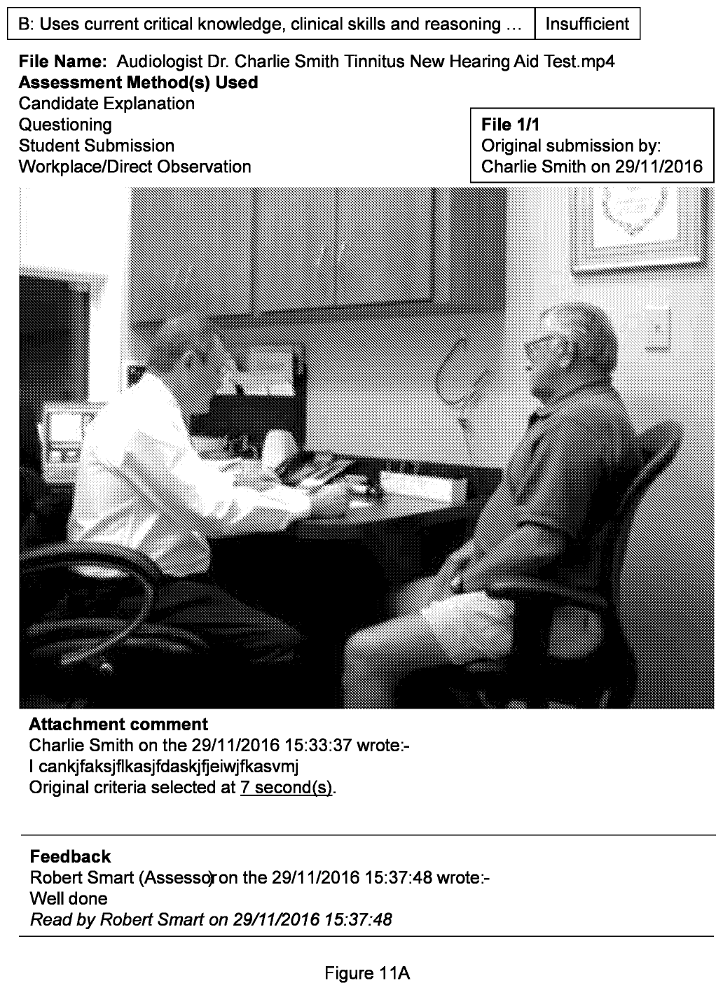

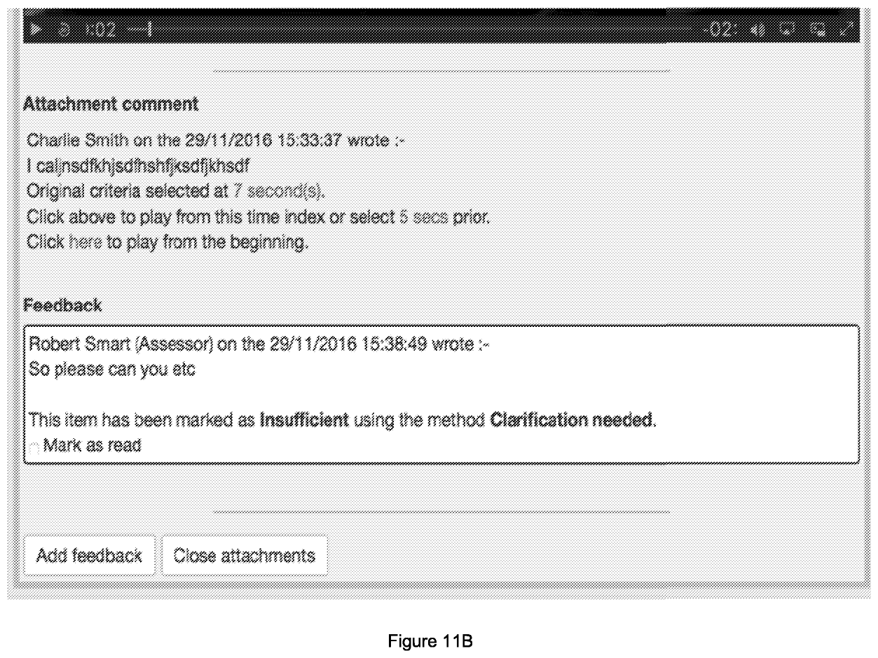

As an example, embodiment of assessment module 30, as illustrated in screen shots FIGS. 11a and 11b, a video, that has been submitted as evidence 18 of competency of the task “Uses current clinical knowledge, clinical skills and reasoning, and client information to plan and conduct assessment and interpret results” has been determined to be insufficient by the Assessor.

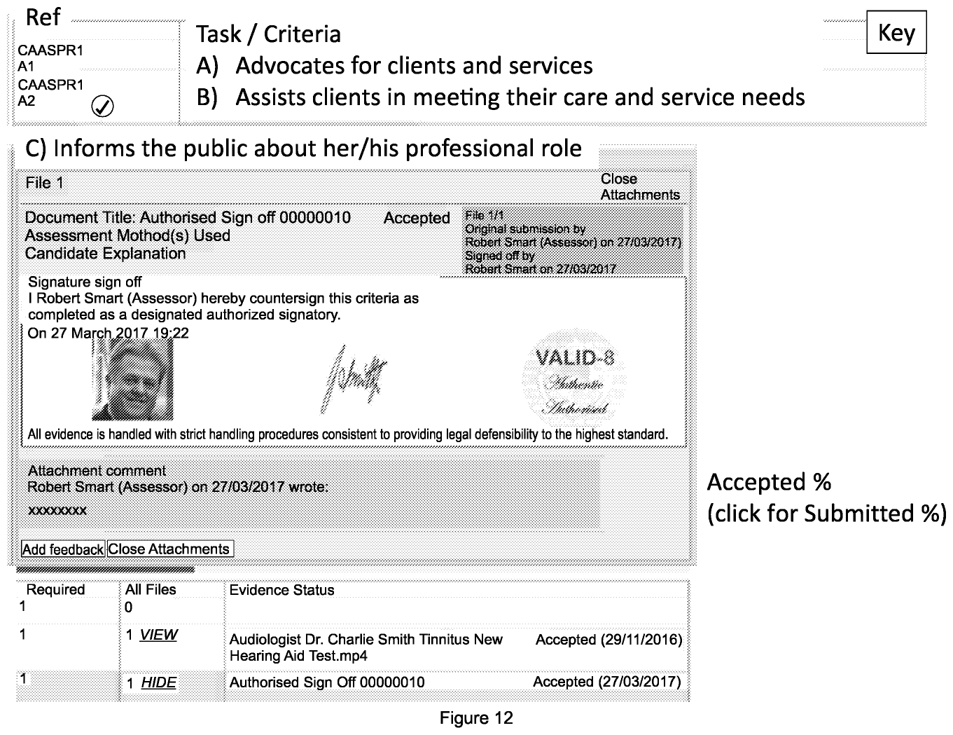

As embodiment of assessment module 30 provides the evaluator with the capability of acknowledging competency of a task and/or criteria without the submission of evidence. As illustrated in screen shot FIG. 12, an Assessor provides a signature sign-off for a particular criterion for a candidate.

An embodiment of assessment module 30 may include an evidence indexing component 32 for location indexing of documentary evidence and time indexing of video evidence. Evidence indexing component 32 provides the ability to identify a specific point in time in a video or a specific portion of a document to demonstrate the successful completion of the task criteria requirement.

Evidence indexing component 32 may provide a link between the specific evidence and the specific task and/or criteria to allow for recall at a later time. This provides an efficient means by which to recall the specific evidence utilized to establish the competency of a specific task and/or criteria.

Evidence indexing component 32 may allow a user to link an exact moment in a piece of video evidence or location within a document to provide instant recall of one or more tasks and criteria 24. The ability to link to these specific time references or documentary locations increases efficiency as such saves significant time to identify proof of skills, knowledge, and ability.

For example, when a video is examined and reviewed, the Assessor, or another person reviewing the video, may select all the relevant tasks and criteria 24 at the time of observation in the video. The time frame for the competency indicators are identified and indexed. A link to the specific indexed time frames are created and embedded within the person's electronic profile. This facilitates the further review of the competency indicators without the need to review the entire video without having to pause, rewind or search the video. Further, this allows multiple links to be generated during one sitting or review, and as such increases efficiency.

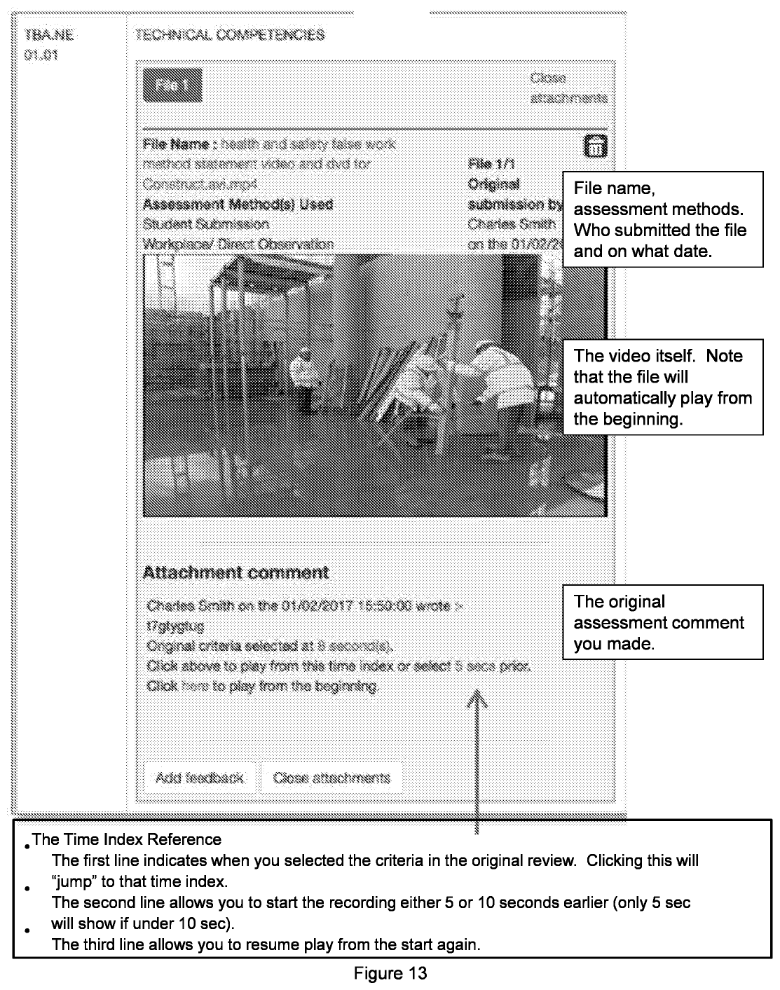

An embodiment of evidence indexing component 32, as illustrated in screen shot FIG. 13, demonstrates video evidence that has been submitted in connection with a particular task. Evidence indexing component 32 provides the Assessor with the capability to identify a particular time frame within the video that satisfies the particular task. In FIG. 13, the particular time frame is set at the “8 second” mark of the video.

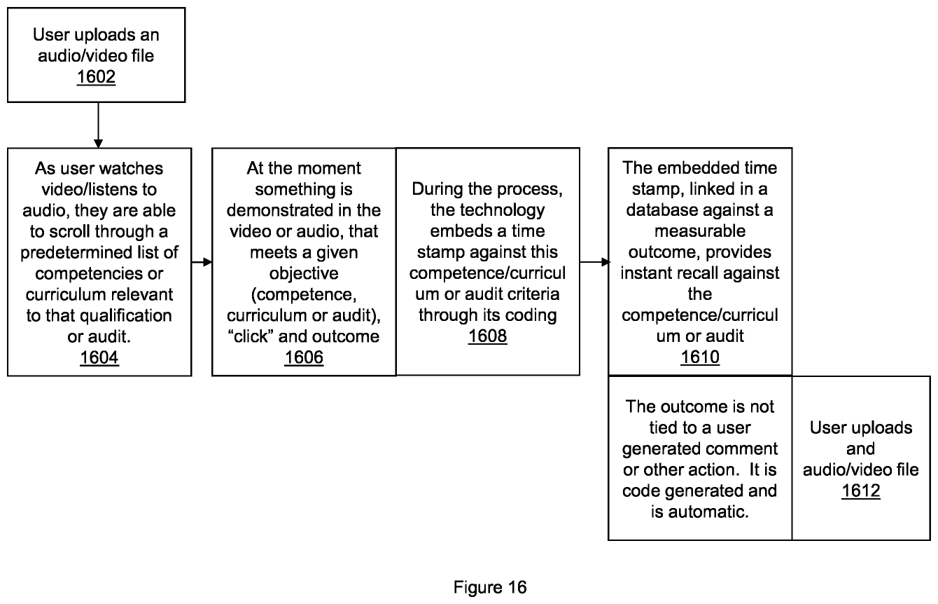

FIG. 16 includes an illustration of a method of creating evidence indexing component 32 for an audio/video (AV) file. In step 1602 a user uploads an AV file which is received by the system 1. In step 1604 while a user watches the video, or listens to the audio, the user is able to view or scroll through a predetermined list of competencies or a curriculum relevant to a qualification or audit. In step 1606, the user determines a moment when one of the predetermined list of competencies is demonstrated in the video or audio that may meet a given objective. The user is able to enter a user input, such as by “clicking” a user interface object on the competency or outcome, or otherwise indicating the moment, for example, by using a voice command. The user input is used by system 1 to determine a selection in the AV file that demonstrates the performance of the competency or task. In step 1608, the system 1 determines and embeds a timestamp that is associated with both the AV file and towards or against the competence/curriculum, or audit criteria. The timestamp is tagged to both the task or criteria and a description of the task, criteria, or curriculum. In step 1610, the embedded timestamp is stored in a database table and linked in the database against the measurable outcome (criteria) and the user, and may be used to provide instant recall against the competency/curriculum, or audit at a later time. The measurable outcome is not tied to a user generated comment or other action. It is generated by code of the system 1 and done automatically, without user interaction. In step 1612 the AV file itself may be uploaded to storage. The selection of the AV file, the AV file, and a description of the task is stored in the database.

In embodiments, when the AV file is a video file, the timestamp may be determined using JavaScript method which may be an HTML 5 video function such as a “currentTime” method. In the case of an audio file other methods may be used. The current time may be used to get a timestamp for the AV being played and may also be used to later set a time in the AV file to play from. This may be uses as the basis to implement and operate a video time index recall providing quick recall when reviewing or auditing AV files.

In embodiments, documents, such as text documents, may be used to demonstrate competency or to provide instructions or background information. In these cases, selection techniques such as defining a rectangle using two diagonal points or defining a circle using a center point and a radius may be used. Similar techniques may also be used to digital files such as photographs.

In embodiments, evidence which is saved in the system 1 may be reviewed for an auditor, reviewer, or the candidate at a later time. The user who wishes to review a digital file is presented with a user interface that lists criteria. For each criteria, one or more digital files may be associated. The user selecting a digital file triggers a user request. In response to receiving a user request, the system 1 accesses the data base to retrieves a digital evidence file (such as an AV file, document, or image) and its associated information including a user, competency, a user, a competency, a curriculum, an audit, etc. The retrieved evidence indicates a user's competency in an ability. The system 1 also retrieves selection information associated with the competency task and that allows the system 1 to quickly indicate the portion of the digital file that demonstrates the user's competency in the ability. The selection may include a timestamp of an AV file, or a selection square, circle, or other shape for documents, photographs, etc. The system 1 uses the selection information to display a selection of the digital file that demonstrates the performance of the criteria. In the case of a video file, the selection may include information that is used by a JavaScript “playfrom” command.

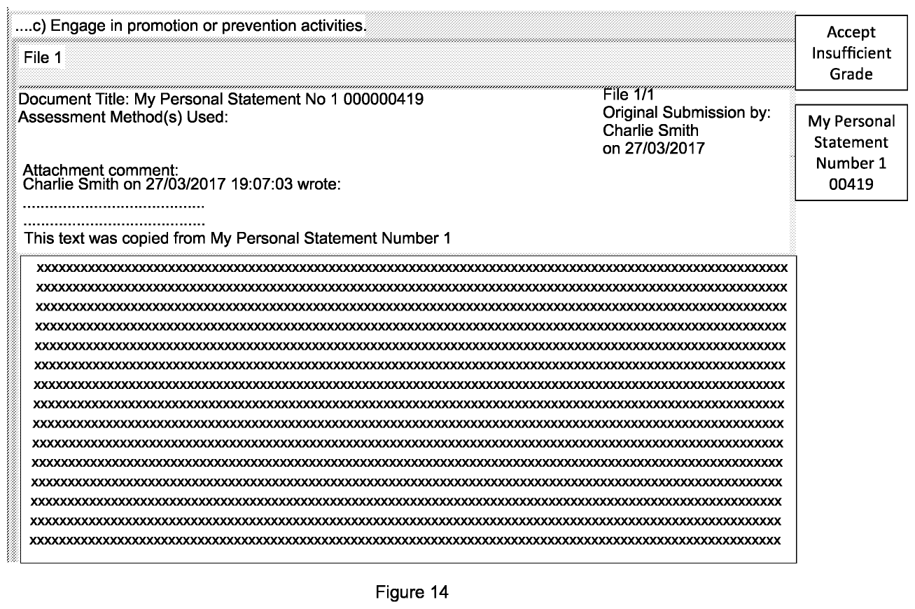

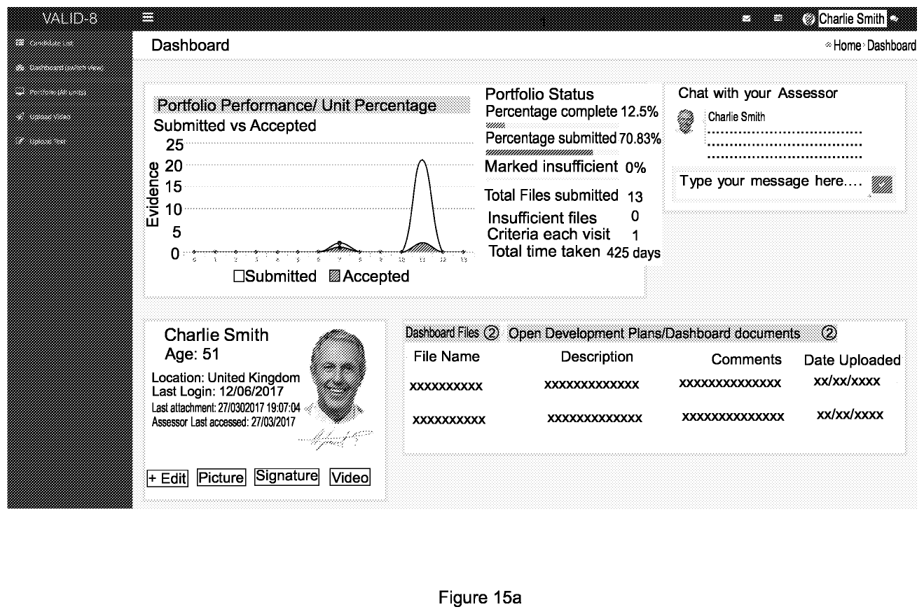

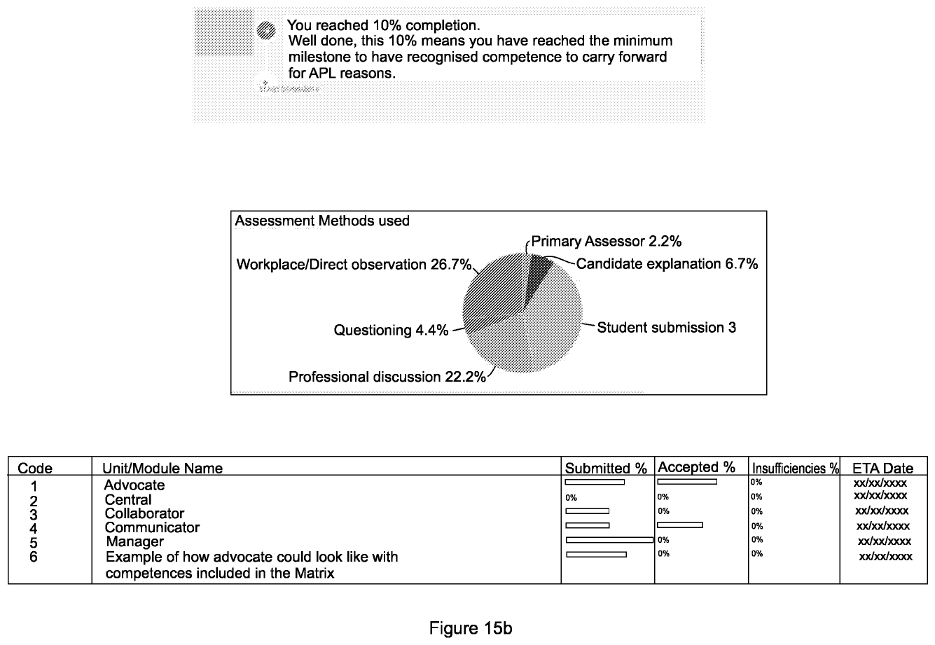

An embodiment of evidence indexing component 32, as illustrated in screen shot FIG. 14, demonstrates documentary evidence that has been submitted in connection with a particular task. Evidence indexing component 32 provides the Assessor with the capability to identify a particular section within the document that satisfies the particular task. In FIG. 13, the particular section is included within the highlighted portion of the document.

Since it is inefficient to continually review entire evidentiary submission at different times, evidence indexing component allows system 1 to be more efficient.

In another embodiment of the present invention, system 1 provides for a second layer of evaluation by a verifier who reviews the assessor's decisions and confirms those decisions or can challenge the decisions for further evaluation

In another embodiment of the present invention, system 1 provides for an auto reference component. This auto reference component automatically cross references multiple specific tasks and criteria. This cross referencing provides the evaluator with the ability to evaluate multiple tasks and criteria as a group. For example, an activity is common across multiple tasks and criteria. When an Assessor determines that the activity has been satisfied based on a specific piece of evidence, that activity within all the tasks and criteria with the common activity may be identified as being satisfied. Further, in conjunction with the evidence indexing component 32, the linked indexed evidence may be linked to each task and criteria at the same time. For example, once an Assessor indexes a specific time frame within a piece of video evidence, the indexed time frame may be linked to each task and criteria with the common activity. This embodiment allows system 1 to be more efficient.

In another embodiment of the present invention, system 1 provides for the automated development of task and criteria completion plans. System 1 may identify those tasks and criteria that not accepted and create a list of such tasks and criteria. As an example, assume system 1 is being utilized with a vocational school and is configured to ensure that the students have satisfied specific tasks and criteria for the specific vocations in which are they are being trained. The development plan can be utilized to guide the student and the school into determining what skills that each student would need to complete to establish competency for the specific vocation.

In another embodiment of the present invention, system 1 provides for the evaluation of the evidence submitted through a natural language process or a text-to-speech process. Keywords and other specific comments or notations may be utilized to help filter or screen persons. This may provide an efficient means to screen large number of applicants for a new job.

In another embodiment of the present invention, system 1 provides the capability for a holistic assessment by the assessor. This capability allows the assessor to approve or not approve a group of tasks and criteria that are related, thus, allowing for a more efficient manner in which to record the competencies of a candidate.

In another embodiment of the present invention, system 1 provides for evidence to be provided through a mobile application. This evidence may be timestamped such that when they are uploaded to system 1, which can also be automatic or at a specific time, the videos cannot be altered. Thus, the video is a raw accurate representation.

An aspect includes a computer implemented method of conducting a competency-based assessment of a candidate. The method includes providing a database including a plurality of electronic profiles, where each electronic profile is for a specific candidate and comprises a candidate identifier and a competency level. Also, updating an electronic profile of a specific candidate to include electronic evidence of achievement, where the evidence of achievement supports a specific competency. Also, indexing or annotating the electronic evidence based on a criterion to obtain processed electronic evidence, and defining a level of competency for the specific competency based on the processed evidence of achievement.

In further aspects, the candidate is a human or non-human animal.

In further aspects, the candidate is an individual, an institute, an organization, a group, or a company.

In further aspects, the candidate is a computer entity, robotic candidate.

In further aspects, each electronic profile comprises biographical information of a candidate.

In further aspects, the biographical information comprises one or more of name, address, title, age, and image of the candidate.

In further aspects, the electronic evidence of an achievement is a result from a standardized test.

In further aspects, the specific competency is user defined.

In further aspects, the specific competency is selected from a pre-set list.

In further aspects, the specific competency is a requirement of an accreditation or program.

In further aspects, the level of competency is a grading or a pass/fail indication.

Aspects further include providing guidance to improve the level of competency and/or feedback.

In further aspects, the electronic evidence of achievement comprises one or more of input text, electronic documents, images, videos, blog entries, multimedia presentation, audio recordings, health and fitness data and map coordinates.

In further aspects, indexing or annotating the electronic evidence comprises reviewing the electronic evidence and bookmarking, highlighting a part of the evidence, time indexing and/or meta data tagging.

In further aspects, details and optional links to bookmarks, highlights, time index, and/or meta data tagging is aggregated into a list in a dedicated section of the user interface.

In further aspects, the dedicated section is searchable.

In further aspects, the dedicated section is a bookmark pane, pop-up box, or separate dialog box.

In further aspects, bookmarks, highlights, time index, and/or meta data tagging are inserted using a mouse, touch pad or touch screen.

In further aspects, each bookmark in the bookmark pane is assigned one or more actions.

In further aspects, the evidence is an electronic document, and the one or more actions comprises going to a specific page or passage in the document.

In further aspects, the evidence is a video or audio recording, and the one or more actions comprises going to a specific frame in the video or point in the audio.

In further aspects, the one or more actions comprises opening a separate file.

In further aspects, the separate file is opened in a new pane.

In further aspects, the separate file is an image file or text file.

In further aspects, the candidate identifier provides sufficient information to identify the candidate.

In further aspects, the candidate identifier is the candidate's name or official identifier.

In further aspects, the candidate identifier is randomly generated or assigned sequentially.

In further aspects, the candidate identifier is defined such that the candidate remains anonymous.

In further aspects, the candidate is a candidate for employment or certification.

In further aspects, the candidate is a patient.

In further aspects, the patient is a patient undergoing treatment.

In further aspects, the candidate is an athlete, a musician, an actor, or student.

In further aspects, the method comprises repeating steps b) to d).

Aspects further include assessing for a change in the level of competency over time.

In further aspects, the change in level of competency is assessed over a predetermined period of time.

In further aspects, the predetermined period of time is a period of time corresponding to a period of time corresponding to a treatment or training period.

In further aspects, the change is an improvement in the level of competency.

In further aspects, the improvement is a measure of effectiveness a treatment or training regime.

In further aspects, the change is a decrease in the level of competency.

In further aspects, the decrease is a measure of disease progression and/or age-related changes.

In further aspects, more than one competency is assessed.

In further aspects, one or more criteria are predetermined based on competency assessed.

In further aspects, one or more criteria are selected from a list or set of criteria.

In further aspects, the criterion is user defined.

In further aspects, the updating of the electronic profile of the specific candidate to include electronic evidence of achievement is completed and/or annotating or indexing the evidence by the specific candidate.

In further aspects, the updating of the electronic profile of the specific candidate to include electronic evidence of achievement and/or annotating or indexing the evidence is completed by third party.

In further aspects, the third party is a known to the candidate or is an independent assessor.

An aspect includes a computer-readable non-transitory storage medium storing instructions executable by a processor, the instructions comprising:

In further aspects, each electronic profile is for a specific candidate and comprises a candidate identifier and a competency level and to update an electronic profile of a specific candidate

In further aspects, the evidence of achievement supports a specific competency. A set of instructions for indexing or annotating the electronic evidence based on a criterion to obtain processed electronic evidence, and a set of instructions for defining a level of competency for the specific competency based on the processed evidence of achievement.

An aspect includes an online system of conducting a competency-based assessment of a candidate. The system is configured to access a database of a plurality of electronic profiles, wherein each electronic profile is for a specific candidate and comprises a candidate identifier and a competency level and to update an electronic profile of a specific candidate to include electronic evidence of achievement. The evidence of achievement supports a specific competency. Also, to index or annotate the electronic evidence based on a criterion to obtain processed electronic evidence and to define a level of competency for the specific competency based on the processed evidence of achievement.

An aspect includes a competency-based assessment system including an electronic profile module for identifying a candidate and competencies of interest, and submission of evidence of competency. Also including a task and criteria module for defining tasks and criteria relating to various competencies, and an assessment module for assessing tasks and criteria based on the submitted evidence.

In further aspects, the system is a web-based system.

In further aspects, the electronic profile module comprises a database comprising a plurality of electronic profiles, wherein each electronic profile is for a specific candidate and comprises a candidate identifier and a competency level.

Aspects further include a user interface.

In further aspects, the user interface is configured to provide for the submission of electronic evidence of achievement for a specific candidate, wherein the evidence of achievement supports a specific competency.

In further aspects, the user interface is configured to provide access to the task and criteria module and/or the assessment module.

In further aspects, the assessment module is configured to allow a user via the user interface to index and/or annotate the submitted evidence.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method of indicating a compliance criteria, the method comprising:
receiving a digital file including evidence of a performance of a task, the task being required to show a competency in an ability;
determining, in response to a first user input, a selection of the digital file demonstrating the performance of the task;
tagging, in response to a second user input, a description of the ability to the selection; and
storing the selection of the digital file, the digital file, and the description.

2. The method of claim 1 wherein the digital file is an audio/visual (AV) file, and the selection includes a timestamp.

3. The method of claim 2 wherein the AV file is a video file, and the timestamp is determined using a JavaScript method, the timestamp indicating a time in the video file corresponding to the performance of the task.

4. The method of claim 3 wherein the JavaScript method is a currentTime method.

5. The method of claim 1 wherein the ability is selected from a list of a plurality of tasks required to show competency.

6. The method of claim 1 wherein the selection is annotated in the digital file.

7. The method of claim 1 wherein the description includes a criteria indicating whether the performance meets the compliance criteria.

8. The method of claim 1 wherein the digital file is a text image file and determining the selection includes selecting a rectangular portion of the text image file.

9. The method of claim 8 further comprising performing character recognition on the rectangular portion, the selection including text obtained by the character recognition.

10. The method of claim 1 further comprising linking a second digital file to the selection and storing the second digital file with the selection of the digital file, the digital file, and the description.

11. The method of claim 1 further comprising determining a probability that the digital file includes evidence of a performance of a second task required to show a competency in a second ability.

12. A method of reviewing a compliance criteria, the method comprising:
receiving a digital file evidence of a performance of a task, the task being required to show a competency in an ability;
receiving a selection of the digital file and a description of the ability, the selection demonstrating performance of the task;
displaying the digital file with the selection indicated as an annotation in the digital file; and
in response to a user selecting the annotation or the description, displaying a portion of the digital file including the selection.

13. The method of claim 12 wherein the digital file is an audio/visual (AV) file, and the selection includes a timestamp.

14. The method of claim 13 wherein the AV file is a video file and displaying a portion of the digital file including the selection includes using a JavaScript method to play the video file from a time indicated by the timestamp.

15. The method of claim 14 wherein the JavaScript method is a “playfrom” method.

16. The method of claim 12 wherein the description is selected from a list of descriptions of a plurality of tasks required to show competency.

17. The method of claim 12 wherein the description includes a criteria indicating whether the performance meets the compliance criteria.
